(19) United States
(12) Patent Application Publication
(10) Pub. No.: US 2011/0192235 A1
(43) Pub. Date: Aug. 11, 2011

(54) DIGITAL DISPLAY MODULE FOR A TORSION WRENCH

(75) Inventor: Shu-Rong Hsu, Taoyuan (TW)

(73) Assignee: TAKEN ETORQUE TECHNOLOGY CO., LTD., Taichung City (TW)

(21) Appl. No.: 12/886,565

(22) Filed: Sep. 21, 2010

(30) Foreign Application Priority Data
Feb. 5, 2010 (TW) 099103581

(51) Int. Cl. G01L 5/24

(52) U.S. Cl. 73/862.23

(57) ABSTRACT

A digital display module for a torsion wrench includes a housing sleeved on a shank of the torsion wrench. A microprocessor is disposed in the housing and includes a normal display model and an inverted display model therein, wherein the normal display model is provided for right-handed operator and the inverted display model is provided for left-handed operator. Multiple function keys are arranged on the periphery of the housing for selecting display models and inputting data. A display screen is mounted on the periphery of the housing and electrically connected to the microprocessor. The display screen is divided into a first display zone for showing numeral and a second display zone for showing scale ratio. A sensor is mounted on a torsion unit of the torsion wrench and electrically connected to the microprocessor for sensing the operating torsion and transmitting torsion data to the microprocessor.

### BACKGROUND OF THE INVENTION

1. Field of the Invention

The present invention relates to a display module, and more particularly to a digital display module for a torsion wrench.

2. Description of Related Art

In early stages, all the torsion wrenches are mechanical such that the operator determines whether the operating torsion is reached to the preinstall torsion value or not by all-or none principle. Consequently, the operator can not understand the change of the torsion during operation. As a result, the operator may overly tight the workpiece when the preinstall torsion value is small and the digital torsion wrench is marketed.

With reference to FIGS. 8 and 9, the display screen (50) of the conventional digital torsion wrench is fixed on the shank such that the operator can not read the torsion value from the display screen (50) when the operating datum has an elevation closed to that of operator's eyes. Furthermore, not all operators are right-handed such that a normal display mode, as shown in FIG. 8, to a right-handed operator becomes an inverted display mode, as shown in FIG. 9, to a left-handed operator. Consequently, the conventional digital torsion wrench needs to be advantageously altered.

The present invention has arisen to mitigate and/or obviate the disadvantages of the conventional digital torsion wrench.

### SUMMARY OF THE INVENTION

The main objective of the present invention is to provide an improved digital display module for a torsion wrench, which includes two display modes respectively provided to right-handed and left-handed operators.

To achieve the objective, the digital display module in accordance with the present invention comprises a housing sleeved on a shank of the torsion wrench. A microprocessor is disposed in the housing and includes a normal display model and an inverted display model therein, wherein the normal display model is provided for right-handed operator and the inverted display model is provided for left-handed operator. An internal formula memory is installed in the microprocessor for saving the edited formula. Multiple function keys are arranged on the periphery of the housing for selecting display models and inputting data. A display screen is mounted on the periphery of the housing and electrically connected to the microprocessor. The display screen is divided into a first display zone for showing numeral and a second display zone for showing scale ratio. A sensor is mounted on a torsion unit of the torsion wrench and electrically connected to the microprocessor for sensing the operating torsion and transmitting torsion data to the microprocessor. A power set is received in the housing for providing energy to the digital display module.

Further benefits and advantages of the present invention will become apparent after a careful reading of the detailed description with appropriate reference to the accompanying drawings.

### BRIEF DESCRIPTION OF THE DRAWINGS

FIG. 1 is a perspective a schematic view of a digital display module for a torsion wrench in accordance with the present invention;

FIG. 2 is a circuit diagram of a digital display module for a torsion wrench in accordance with the present invention;

FIG. 3 is a side plan view for showing the operational mode in a normal visual angle relative to a datum of the workpiece;

FIG. 4 is a side plan view for showing the operational mode in a great visual angle relative to the datum of the workpiece;

FIG. 5 is a perspective view of the digital display module when the display screen displays in an inverted display model;

FIG. 6 is a perspective view of the digital display module when the display screen displays in a normal display model;

FIG. 7 is a top plan view of the display screen that has seven light bars lighted;

FIG. 8 is a top plan view of a conventional display screen of a torsion wrench when being operated by a right-handed operator; and

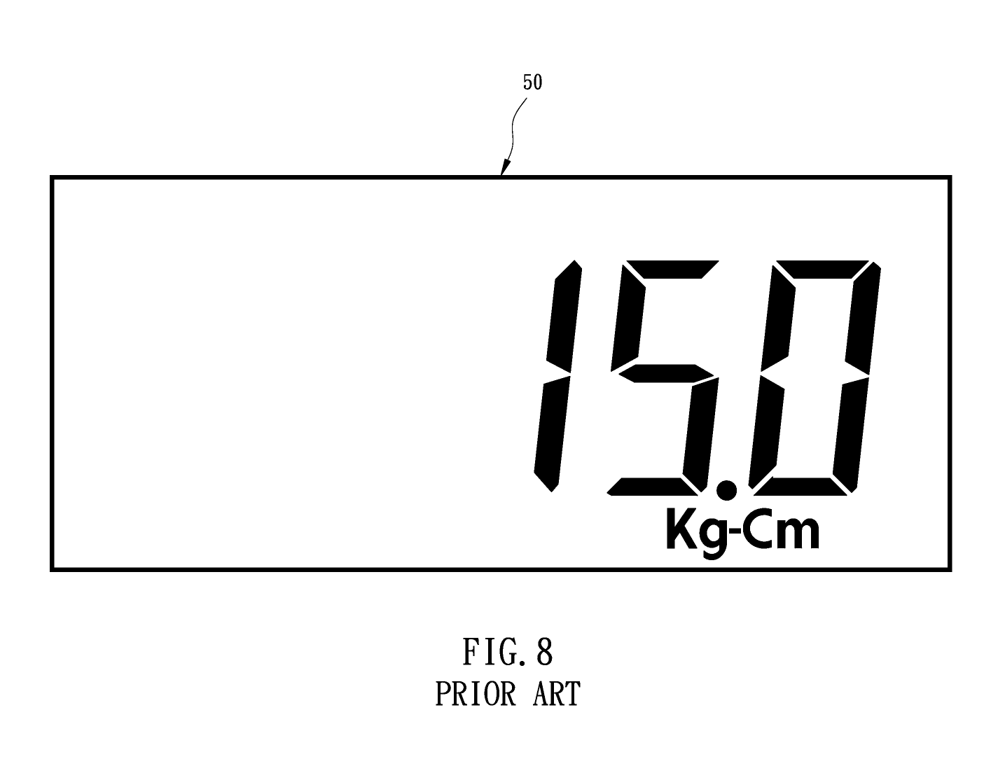

FIG. 9 a top plan view of a conventional display screen of a torsion wrench when being operated by a left-handed operator.

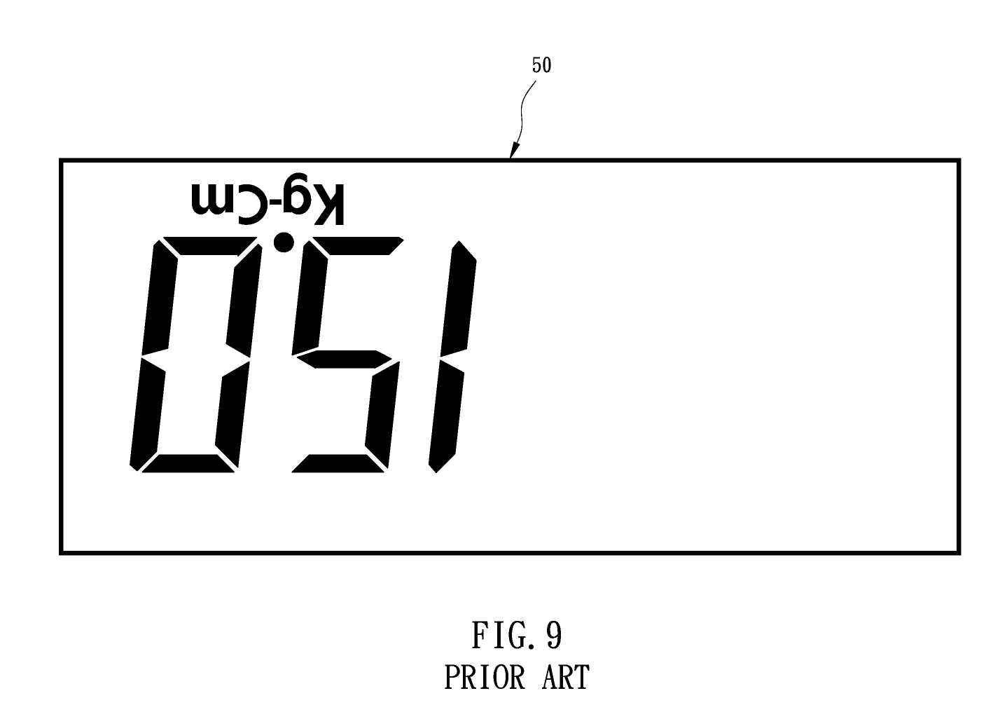

### DETAILED DESCRIPTION OF THE INVENTION

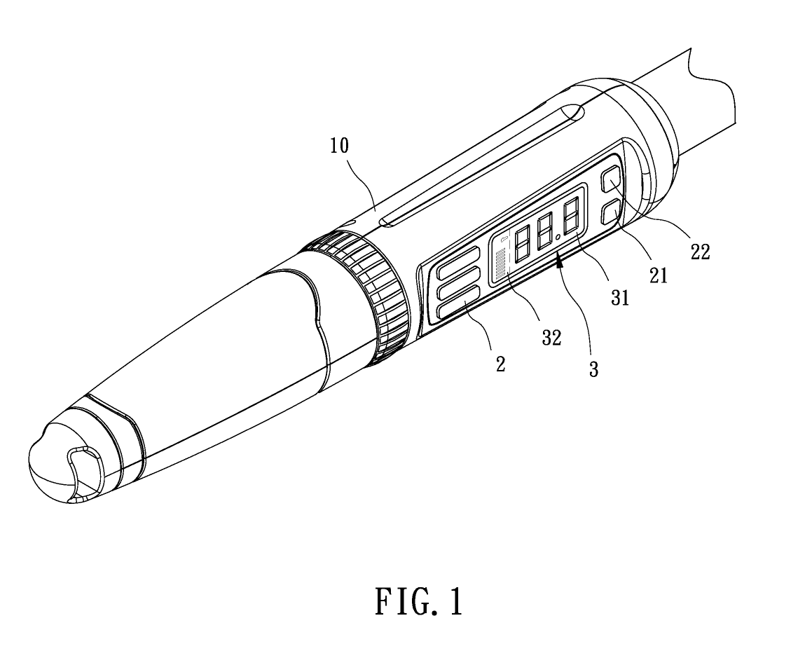

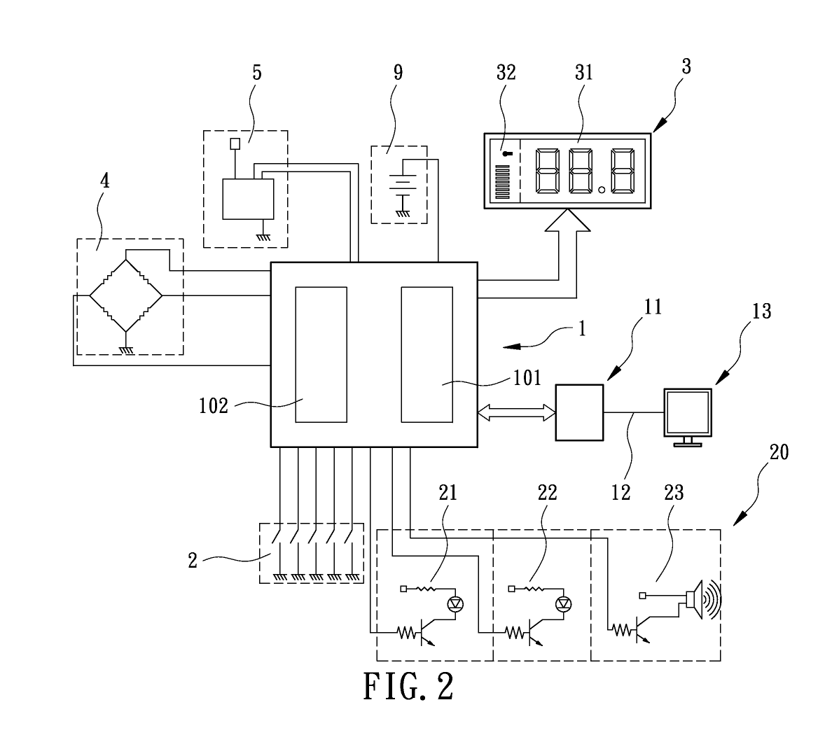

Referring to the drawings and initially to FIGS. 1-2, a digital display module for a torsion wrench in accordance with the present invention comprises housing (10) rotatably sleeved on a shank of the torsion wrench. A microprocessor (1) is disposed in the housing (10) and multiple function keys (2) are arranged on the periphery of the housing (10) for selecting display modes and input data. A display screen (3) is mounted on the periphery of the housing (10) and electrically connected to the microprocessor (1). A sensor (4) mounted on a torsion unit of the torsion wrench and electrically connected to the microprocessor (1). A permanent memory IC (5) is mounted in the housing (10) and electrically connected to the microprocessor (1). An alarm unit (20) is disposed in the housing and electrically connected to the microprocessor (1) for alarming the operator by light or sound when the operating torsion value is near the installed torsion value. A power set (9) is mounted in the housing (10) for providing energy to the digital display module in accordance with the present invention. A transmission interface (11) is disposed on the housing (10) and electrically connected to the microprocessor (1).

The microprocessor (1) includes a normal display model (101) and an inverted display model (102) disposed therein, and an internal formula memory is installed in the microprocessor (1) for saving the edited formula. The alarm unit (20) includes an LED backlight module (21) and a LED (22) respectively disposed on the housing (10) for alarming the operator by light. The alarm unit (20) further includes a speaker (23) disposed in the housing (10) for alarming the operator by sound. The microprocessor (1) can read data from the permanent memory IC (5) or timely save the data in the permanent memory IC (5) via the circuit arranged therebetween. Consequently, the install data and the check data can be safely saved in the permanent memory IC (5) even if a broken circuit is occurred during operating. The microprocessor (1) can deliver computed data and torsion data to a person computer (13) via the transmission interface (11) and an extra cable (12). Certainly, the microprocessor (1) also can receive the data from the person computer (13) via the extra cable (12) and the transmission interface (11).

The sensor (4) is provided to sense the loaded torsion from the torsion wrench and transmit the timely torsion value to the microprocessor (1) via analogy signal. Then, the microprocessor (1) transforms the analogy signal into digital signal that is displayed on the display screen (3). The display screen (3) is divided into a first display zone (31) for showing numeral and a second display zone (32) for showing scale ratio.

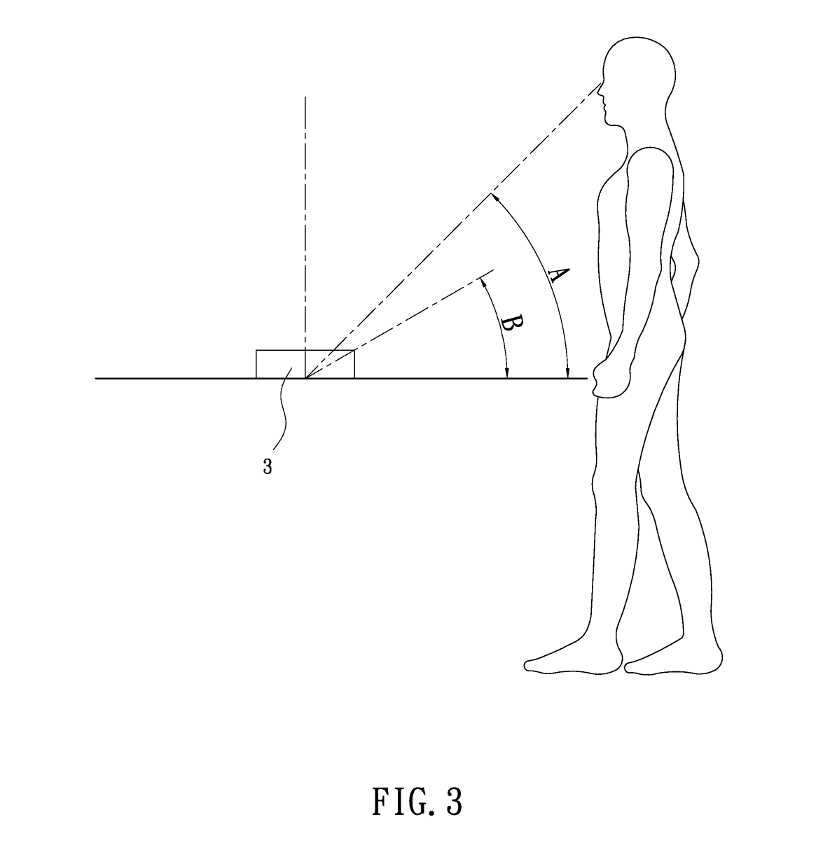

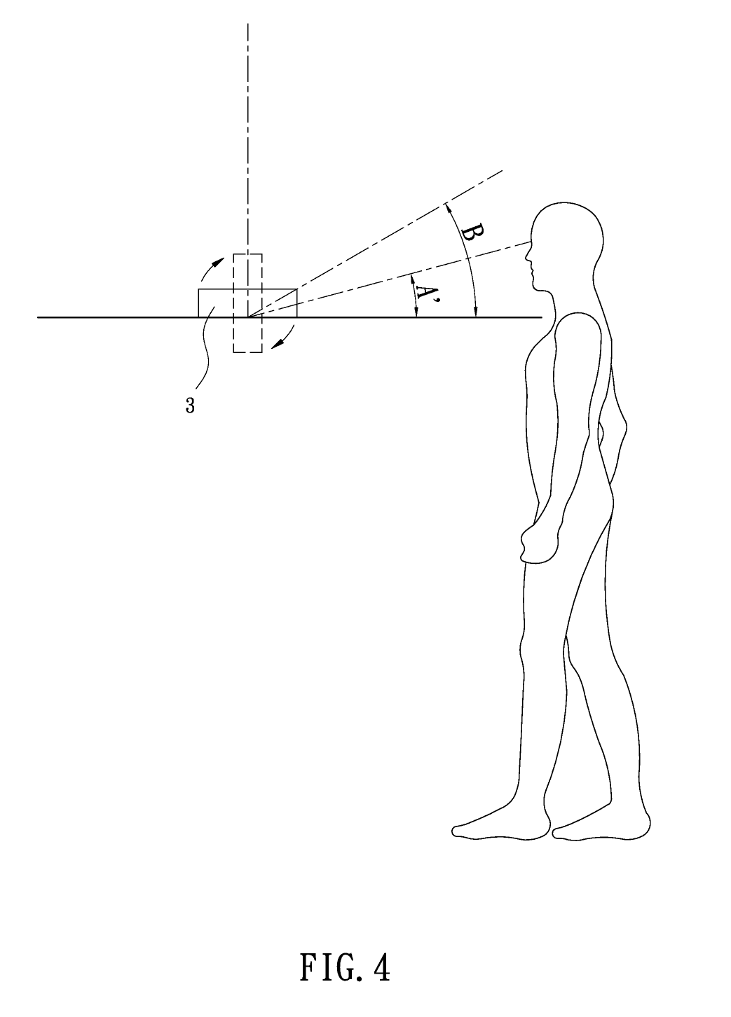

With reference to FIG. 3, the display screen (3) is horizontally arranged when the included angle (A), between the operator's line of vision and the operating datum, is greater than the complementary angle (B) of the visual angle of the display screen (3). With reference to FIG. 4, the display screen (3) is turned toward the operator when the included angle (A), between the operator's line of vision and the operating datum, is smaller than the complementary angle (B) of the visual angle of the display screen (3). Consequently, the operator can easily and clearly read the operating torsion value via the display screen (3) in different angles and elevations.

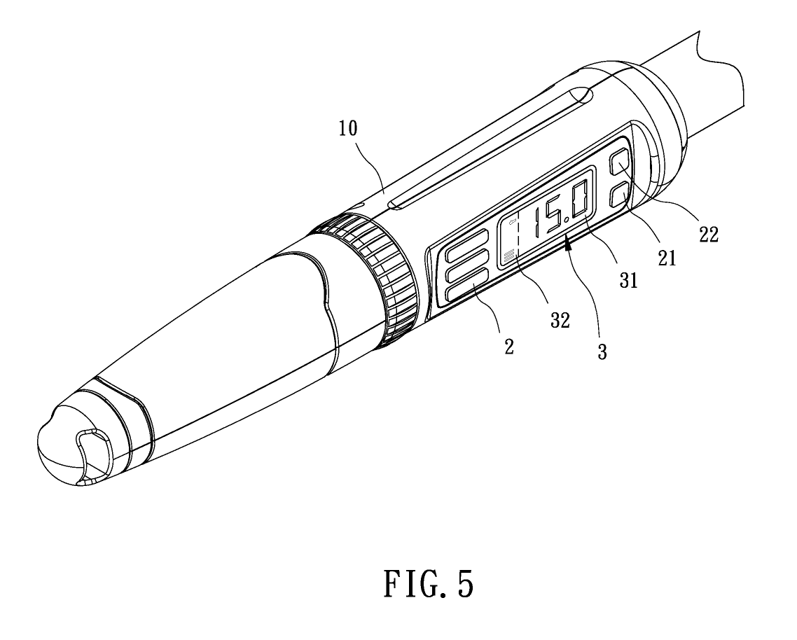

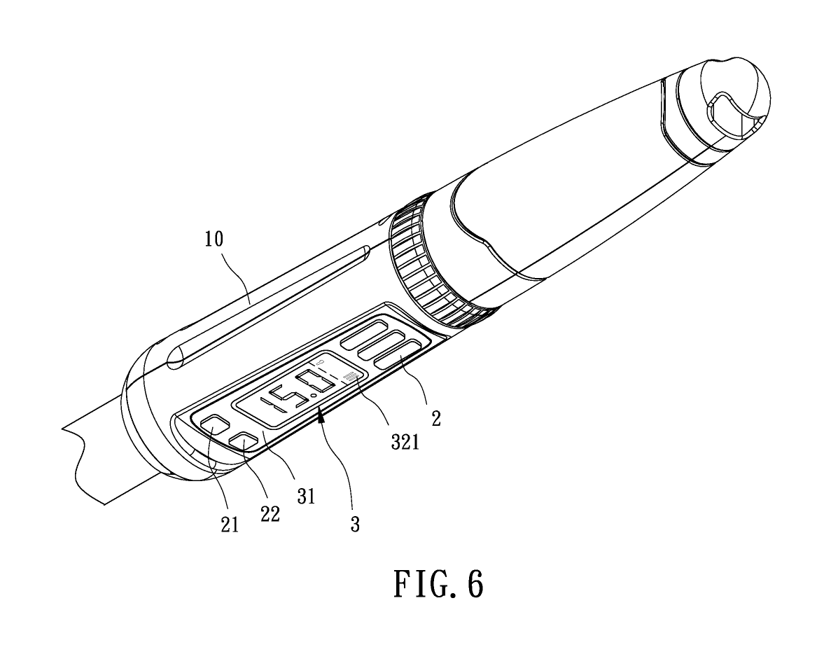

In addition, the display screen (3) has two display modes that can be selected by the function keys (2). The two display modes of the display screen (3) respectively correspond to the normal display model (101) and the inverted display model (102) installed in the microprocessor (1). With reference to FIG. 5, the inverted display model (102) is selected when the operator is left-handed. With reference to FIG. 6, the normal display model (101) is selected when the operator is right-handed. The operators, including right-handed and left-handed, can respectively select a suitable display model (101/102) and easily read the torsion value from first display zone (31) of the display screen (3).

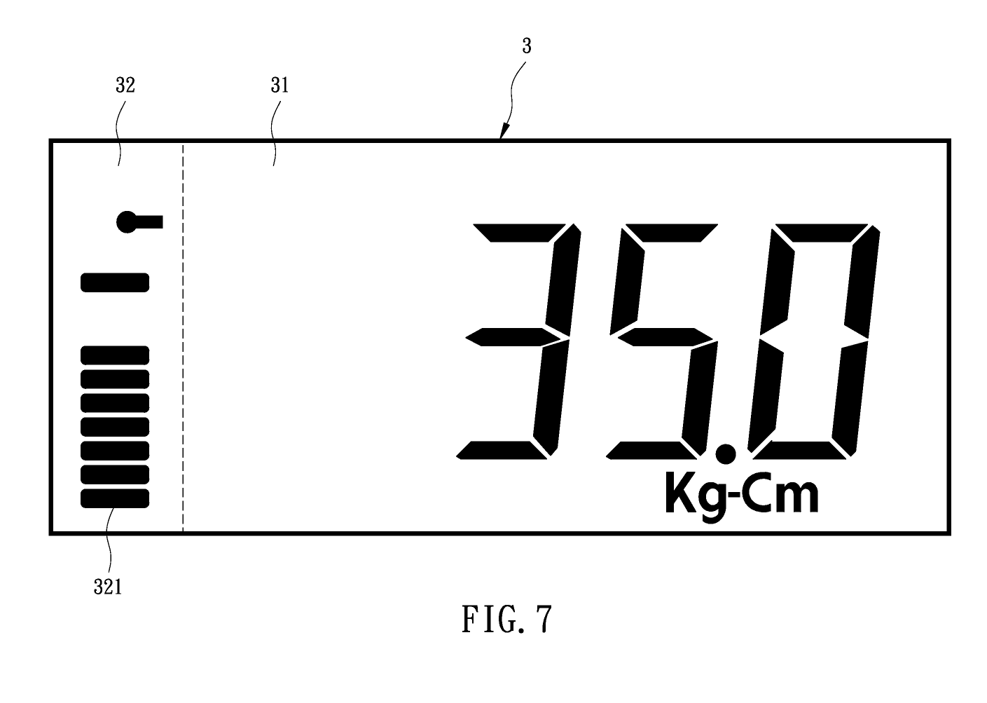

Another characteristic of the digital display module in accordance with the present invention is the second display zone (32) of the display screen (3), which including ten light bars (321) for showing the ratio of the operating torsion. With reference to FIG. 6, the operating torsion is 15 kg-cm and three light bars (321) are lighted, that's the torsion ratio is 30%, when the preinstall torsion value is 50 kg-cm. Consequently, the operator can acceptably greatly force. With reference to FIG. 7, seven light bars (321) are lighted when the operating torsion reaches 35 kg-cm, that's the torsion ratio is 70% for informing that the operator needs to lightly operating to avoid an excess of operation.

Although the invention has been explained in relation to its preferred embodiment, it is to be understood that many other possible modifications and variations can be made without departing from the spirit and scope of the invention as hereinafter claimed.

What is claimed is:

1. A digital display module for a torsion wrench, comprising:
a housing adapted to be sleeved on a shank of the torsion wrench;
a microprocessor disposed in the housing, the microprocessor including a normal display model and an inverted display model therein, wherein the normal display model is provided for right-handed operator and the inverted display model is provided for left-handed operator, an internal formula memory installed in the microprocessor for saving the edited formula;
multiple function keys arranged on the periphery of the housing for selecting display models and inputting data;
a display screen mounted on the periphery of the housing and electrically connected to the microprocessor, the display screen divided into a first display zone for showing numeral and a second display zone for showing scale ratio;
a sensor adapted to be mounted on a torsion unit of the torsion wrench and electrically connected to the microprocessor for sensing the operating torsion and transmitting torsion data to the microprocessor; and
a power set is received in the housing for providing energy to the digital display module.

2. The digital display module as claimed in claim 1, wherein the housing is rotary relative to the shank of the torsion wrench.

3. The digital display module as claimed in claim 1 further comprising a permanent memory IC mounted in the housing and electrically connected to the microprocessor, wherein the microprocessor can read data from the permanent memory IC and timely save data in the permanent memory IC.

4. The digital display module as claimed claim 1 further comprising a transmission interface disposed on the housing and electrically connected to the microprocessor such that the microprocessor can transmit computed data to a personal computer.

5. The digital display module as claimed in claim 2 further comprising a permanent memory IC mounted in the housing and electrically connected to the microprocessor, wherein the microprocessor can read data from the permanent memory IC and timely save data in the permanent memory IC.

6. The digital display module as claimed claim 2 further comprising a transmission interface disposed on the housing and electrically connected to the microprocessor such that the microprocessor can transmit computed data to a personal computer.

7. The digital display module as claimed claim 3 further comprising a transmission interface disposed on the housing and electrically connected to the microprocessor such that the microprocessor can transmit computed data to a personal computer.

8. The digital display module as claimed in claim 1, wherein the second display zone of the display screen includes ten light bars such that the operator can read the ratio of the operating torsion via number of lighted light bars.
